(19) United States
(12) Patent Application Publication
(10) Pub. No.: US 2016/0342314 A1
(43) Pub. Date: Nov. 24, 2016

(54) PERSONALIZED GRAPHICAL USER INTERFACE CONTROL FRAMEWORK

(71) Applicant: Microsoft Technology Licencing, LLC, Redmond, WA (US)

(72) Inventor: Joseph Carl Dickerson, Dacula, GA (US)

(21) Appl. No.: 14/718,016

(22) Filed: May 20, 2015

(51) Int. Cl. G06F 3/0484

(52) U.S. Cl. CPC G06F 3/04845; G06F 3/04842; G06F 3/04847

(57) ABSTRACT

Various technologies described herein pertain to managing a graphical user interface of a computer-executable application for a user. A customization of a graphical control element for a function of the computer-executable application in the graphical user interface can be identified for the user. The graphical control element can be selectable to facilitate performance of the function of the computer-executable application. The customization of the graphical control element for the function of the computer-executable application can be identified based on individual usage data of the user for functions of the computer-executable application and aggregated usage data of a plurality of users for the functions of the computer-executable application. Further, the graphical user interface can be modified to incorporate the customization of the graphical control element for the function of the computer-executable application.

### BACKGROUND

Graphical user interfaces can allow users to interact with electronic devices through graphical control elements. For instance, a graphical control element can be selectable by a user to facilitate performance of a function of a computer-executable application. Conventionally, user interfaces may have a steep learning curve. Users may be unaware of functions available as part of computer-executable applications, even for a frequently used computer-executable application. Moreover, personalizing a traditional graphical user interface through manual customization can be difficult and time consuming.

### SUMMARY

Described herein are various technologies that pertain to managing a graphical user interface of a computer-executable application for a user. A customization of a graphical control element for a function of the computer-executable application in the graphical user interface can be identified for the user. The graphical control element can be selectable to facilitate performance of the function of the computer-executable application. The customization of the graphical control element for the function of the computer-executable application can be identified based on individual usage data of the user for functions of the computer-executable application and aggregated usage data of a plurality of users for the functions of the computer-executable application. Further, the graphical user interface can be modified to incorporate the customization of the graphical control element for the function of the computer-executable application.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that generates a personalized graphical user interface of a computer-executable application.

FIG. 2 illustrates a functional block diagram of an exemplary system that incorporates a customization of a graphical control element for a function of the computer-executable application in the graphical user interface responsive to a received input.

FIG. 3 illustrates a functional block diagram of an exemplary system that controls personalization of the graphical user interface of the computer-executable application for the user.

FIGS. 4-6 illustrate various exemplary configurations of a graphical user interface of a computer-executable application in accordance with various aspects.

FIG. 7 illustrates another exemplary graphical user interface of a computer-executable application.

FIG. 8 is a flow diagram that illustrates an exemplary methodology of managing a graphical user interface of a computer-executable application for a user.

FIG. 9 illustrates an exemplary computing device.

FIG. 10 illustrates an exemplary computing system.

### DETAILED DESCRIPTION

Various technologies pertaining to a personalized graphical user interface control framework are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

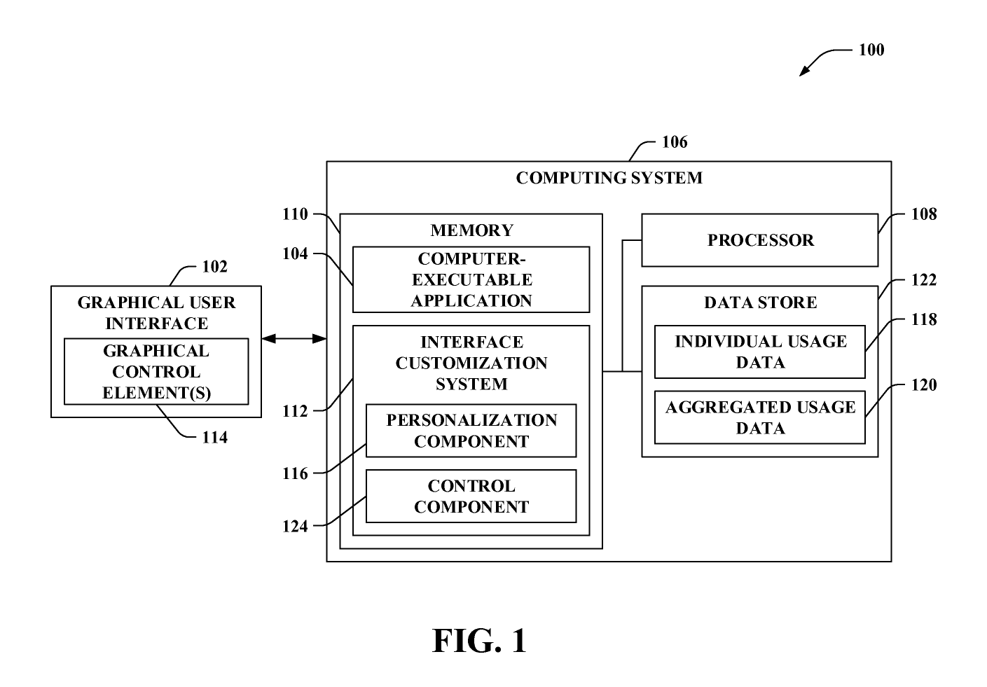

Referring now to the drawings, FIG. 1 illustrates a system 100 that generates a personalized graphical user interface 102 of a computer-executable application 104. The system 100 includes a computing system 106. The computing system 106 includes at least one processor 108 and memory 110. The processor 108 is configured to execute instructions loaded into the memory 110 (e.g., one or more systems loaded into the memory 110 are executable by the processor 108, one or more components loaded into the memory 110 are executable by the processor 108, etc.). As described in greater detail herein, the memory 110 includes an interface customization system 112 configured to manage the graphical user interface 102 of the computer-executable application 104 for a user. The interface customization system 112 is executable by the processor 108; thus, the memory 110 includes instructions configured to manage personalization of the graphical user interface 102 of the computer-executable application 104.

Moreover, the memory 110 includes the computer-executable application 104. The computer-executable application 104 can include a plurality of functions. Substantially any type of computer-executable application is intended to fall within the scope of the hereto appended claims. Examples of the computer-executable application 104 include, but are not limited to, an operating system, a word processing application, an accounting application, a spreadsheet application, a project management application, an email application, a web browser application, a media player, a video game, a media content creation and/or editing application, etc. Although not shown, it is to be appreciated that the computer-executable application 104 can include the interface customization system 112. While one computer-executable application is described herein, namely the computer-executable application 104, it is contemplated that the memory 110 can include more than one computer-executable application, and the interface customization system 112 (or more than one interface customization system) can manage respective graphical user interfaces for such computer-executable applications.

According to various examples, the computing system 106 can be or include a computing device. Pursuant to various illustrations, the computing device can be a desktop computing device, a mobile computing device (e.g., a laptop computing device, a mobile telephone, a smartphone, a tablet computing device, a wearable computing device, a handheld computing device, a portable gaming device, a personal digital assistant, a camera, etc.), a gaming console, an in-vehicle communications and infotainment system, an electronic kiosk, or the like. In accordance with other examples, the computing system 106 can be or include one or more server computing devices. For instance, the computing system 106 can be or include one or more datacenters, where a datacenter includes a plurality of server computing devices. Additionally or alternatively, the computing system 106 can be a distributed computing system.

The interface customization system 112 can control the graphical user interface 102 for the computer-executable application 104. The graphical user interface 102 can be presented by an output device (e.g., a display device etc.). The output device can be part of the computing system 106. Additionally or alternatively, the output device can be separate from the computing system 106; accordingly, the output device can be in communication with the computing system 106. Moreover, interaction with the graphical user interface 102 can be detected by an input device, which can receive user input. The input device can be part of the computing system 106. Additionally or alternatively, the input device can be separate from the computing system 106, but in communication with the computing system 106. According to an example, the input device and the output device can be a common device (e.g., a touchscreen); however, the claimed subject matter is not so limited.

The graphical user interface 102 can include one or more graphical control elements 114. The graphical control elements 114 can include icons, items in menu(s), buttons, sliders, tabs, check boxes, items in drop-down list(s), a combination thereof, and so forth. A graphical control element can be selectable (e.g., responsive to user input received via the input device) to facilitate performance of a corresponding function of the computer-executable application 104. Thus, the graphical user interface 102 can include various graphical control elements 114 selectable to facilitate performance of various functions of the computer-executable application 104.

The interface customization system 112 can modify the graphical user interface 102 over time. For instance, one or more of the graphical control elements 114 can be added, removed, repositioned, resized, color changed, or otherwise altered by the interface customization system 112 over time. The graphical user interface 102 can be personalized for the user by the interface customization system 112 to incorporate the graphical control elements 114 for the functions of the computer-executable application 104 that the user frequently utilizes, which can increase user efficiency when interacting with the graphical user interface 102 (e.g., by reducing an amount of time to cause performance of such functions). Moreover, such personalization of the graphical user interface 102 can simplify customizing the graphical user interface 102 as compared to conventional manual approaches (e.g., the conventional approaches may be difficult and time consuming to carry out). Further, the interface customization system 112 can enable a graphical control element of a function that may be unknown to the user (but beneficial to the user) to be surfaced; for instance, the user may be unaware that the computer-executable application 104 includes the function, but since the function is related to another function that is frequently used by the user, it may be incorporated into the graphical user interface 102 and thereafter employed by the user.

The interface customization system 112 can include a personalization component 116 configured to identify a customization of a graphical control element (e.g., one of the graphical control elements 114) for a function of the computer-executable application 104 in the graphical user interface 102 for the user. As noted above, the graphical control element can be selectable to facilitate performance of the function of the computer-executable application 104. The customization of the graphical control element for the function of the computer-executable application 104 can be identified by the personalization component 116 based on individual usage data 118 of the user for functions of the computer-executable application 104. Moreover, the customization of the graphical control element for the function of the computer-executable application 104 can be identified by the personalization component 116 based on aggregated usage data 120 of a plurality of users for the functions of the computer-executable application 104.

The computing system 106 can include a data store 122. The data store 122 can retain the individual usage data 118 of the user for the functions of the computer-executable application 104. The individual usage data 118 of the user can specify respective frequencies of use of the functions of the computer-executable application 104 by the user. The data store 122 can also retain the aggregated usage data 120 of the plurality of the users for the functions of the computer-executable application 104. The aggregated usage data 120 of the plurality of the users can specify respective frequencies of use of the functions of the computer-executable application 104 by the plurality of users. While not shown, it is to be appreciated that the data store 122 can also retain individual usage data and/or aggregated usage data for functions of differing computer-executable application(s) in addition to the computer-executable application 104.

The interface customization system 112 can further include a control component 124 configured to modify the graphical user interface 102 to incorporate the customization of the graphical control element for the function of the computer-executable application 104. For example, the customization of the graphical control element can be inclusion of the graphical control element for the function of the computer-executable application 104 in the graphical user interface 102 for the user. According to another example, the customization of the graphical control element can include repositioning the graphical control element for the function of the computer-executable application 104 in the graphical user interface 102 for the user. Pursuant to yet another example, the customization of the graphical control element can include removal of the graphical control element for the function of the computer-executable application 104 from the graphical user interface 102 for the user. By way of yet another example, the customization the graphical control element can include resizing of the graphical control element for the function of the computer-executable application 104 in the graphical user interface 102 for the user. It is also contemplated that one or more customizations such as changes in color, thickness, transparency, or the like can be applied to the graphical control element for the function of the computer-executable application 104 in the graphical user interface 102 for the user.

The control component 124 can be configured to automatically modify the graphical user interface 102 to incorporate the customization of the graphical control element for the function of the computer-executable application 104 without input from the user. For instance, the graphical user interface 102 can be dynamically updated by the control component 124 over time without explicitly opting in to each graphical control element customization. Alternatively, the control component 124 can be configured to modify the graphical user interface 102 to incorporate the customization of the graphical control element for the function of the computer-executable application 104 responsive to input from user (e.g., the input can signify that the customization is to be incorporated into the graphical user interface 102).

As set forth above, the personalization component 116 can identify the customization of the graphical control element for the function based on the individual usage data 118 and the aggregated usage data 120. The individual usage data 118 can include a usage pattern of the user (e.g., a profile of the user, etc.).

The aggregated usage data 120, for example, can include an aggregation of usage patterns of the computer-executable application 104 across all (or most) users of the computer-executable application 104. Overall usage of the computer-executable application 104 can thus be used to refactor the graphical user interface 102.

According to another example, the plurality of the users can include users of the computer-executable application 104 that share a characteristic (or characteristics) with the user. Following this example, the plurality of the users can exclude users of the computer-executable application 104 that lack the characteristic (or characteristics). Exemplary characteristics include age, gender, geographic region, usage time, application usage, and the like; however, it is contemplated that substantially any other characteristics are intended to fall within the scope of the hereto appended claims. Thus, pursuant to this example, the aggregated usage data 120 can include an aggregation of usage patterns of the computer-executable application 104 across the plurality of the users that share the characteristic (or characteristics) with the user.

According to yet another example, the aggregated usage data 120 can include the aggregation of the usage patterns of the computer-executable application 104 across all (or most) users of the computer-executable application 104 in addition to the aggregation of the usage patterns of the computer-executable application 104 across the plurality of the users that share the characteristic (or characteristics) with the user. Following this example, the usage pattern of the user (e.g., the individual usage data 118), the aggregation of the usage patterns across all (or most) users, and the aggregation of the usage patterns across the plurality of the users that share the characteristic (or characteristics) with the user can be evaluated by the personalization component 116 to determine the customization of the graphical control element for the function of the computer-executable application 104.

The aggregated usage data 120 for the plurality of the users for the functions of the computer-executable application 104 can be for a version of the computer-executable application 104 executed by the computing system 106, for example. Thus, pursuant to this example, the aggregated usage data 120 can exclude usage data for one or more differing versions of the computer-executable application 104. By way of illustration, a version of a computer-executable application for a mobile computing device can differ from a version of the computer-executable application for a desktop computing device. Such versions can include differing sets of functions; for instance, the mobile computing device version of the computer-executable application can include a subset of the functions of the desktop version of the computer-executable application. Moreover, the differing versions of the computer-executable application can have different surfacing paradigms for the graphical control elements of the graphical user interface 102, since different functions can be used more frequently with one version of the computer-executable application as compared to a different version of the computer-executable application.

Moreover, the aggregated usage data 120 of the plurality of the users for the functions of the computer-executable application 104 can specify a link between a first function of the computer-executable application 104 and a differing, second function of the computer-executable application 104 (or a plurality of differing functions). Accordingly, the personalization component 116 can be configured to identify the customization of the graphical control element for the first function of the computer-executable application 104 based on a frequency of use of the second function by the user indicated in the individual usage data 118 of the user and the link between the first function of the computer-executable application 104 and the second function of the computer-executable application 104 as specified by the aggregated usage data 120. According to an example, the link between the first function of the computer-executable application and the second function of the computer-executable application can be indicative of a predefined relation between the first function and the second function. According to another example, the link between the first function of the computer-executable application and the second function of the computer-executable application can be indicative of a correlation between respective frequencies of use of the first function and the second function in the aggregated usage data 120.

For instance metadata can be assigned to the functions of the computer-executable application 104 based on information architecture of the functionality. Similar functions can be aligned together and linked via a scoring mechanism. The scoring mechanism is dynamic with inputs based on the individual usage data 118 of the user (e.g., based on a profile) and the aggregated usage data 120; the aggregated usage data 120 can include the aggregation of the usage patterns of users of the computer-executable application 104 in a region that share a characteristic (or characteristics) and the aggregation of the usage patterns across users. Moreover, the computer-executable application 104 can include an index of functionality that lists functions along with the usage data. Such functions can be cross-indexed to link similar functions together. The indexing can provide for related and/or secondary functions to be surfaced by the personalization component 116 in the graphical user interface 102 when graphical control elements of primary functions are included in the graphical user interface 102.

Further, the individual usage data 118 of the user for the functions of the computer-executable application 104 and/or the aggregated usage data 120 of the plurality of the users for the functions of the computer-executable application 104 can be updated over time. Thus, the personalization component 116 can be configured to identify the customization of the graphical control element for the function of the computer-executable application 104 in the graphical user interface 102 for the user at a given time based on the updated individual usage data of the user for the function of the computer-executable application 104 corresponding to the given time and/or the updated aggregated usage data of the plurality of the users for the functions of the computer-executable application 104 corresponding to the given time.

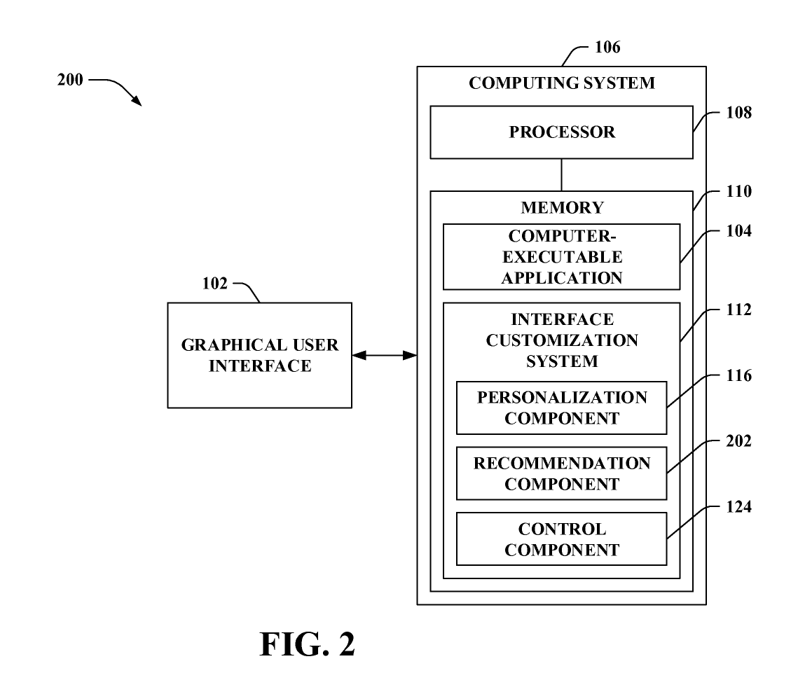

Turning to FIG. 2, illustrated is a system 200 that incorporates a customization of a graphical control element for a function of the computer-executable application 104 in the graphical user interface 102 responsive to a received input. The system 200 includes the computing system 106, and the computing system 106 can include the computer-executable application 104 and the interface customization system 112. Again, the interface customization system 112 can include the personalization component 116 and the control component 124. The personalization component 116 can be configured to identify the customization of the graphical control element for the function of the computer-executable application 104 in the graphical user interface 102 for the user.

The interface customization component 112 can further include a recommendation component 202 configured to generate a prompt that specifies the customization of the graphical control element for the function of the computer-executable application 104. The prompt can indicate the function and/or describe the customization. Moreover, the recommendation component 202 can be configured to receive an input responsive to the prompt. The input can be indicative of acceptance or rejection of the customization of the graphical control element.

Further, the control component 124 can be configured to modify the graphical user interface 102 to incorporate the customization of the graphical control element for the function of the computer-executable application 104 responsive to receipt of the input indicative of acceptance of the customization of the graphical control element. The control component 124 can also be configured to inhibit modification of the graphical user interface 102 to incorporate the customization of the graphical control element for the function of the computer-executable application 104 responsive to receipt of the input indicative of rejection of the customization of the graphical control element.

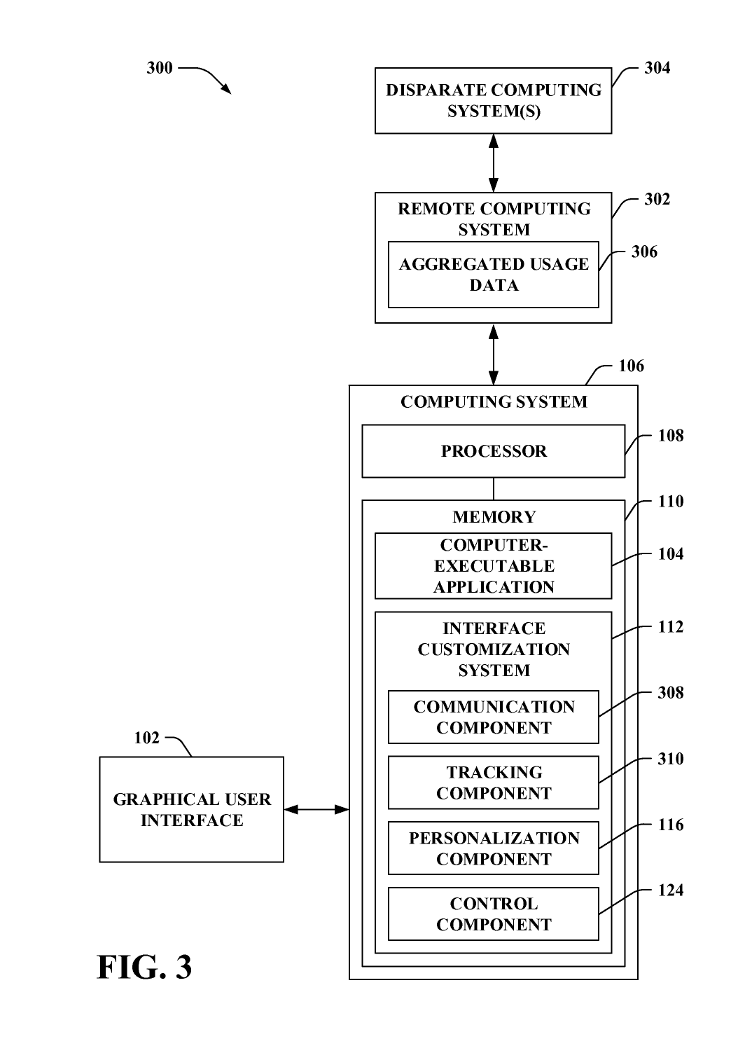

With reference to FIG. 3, illustrated is another system 300 that controls personalization of the graphical user interface 102 of the computer-executable application 104 for the user. The system 300 includes the computing system 106 and a remote computing system 302. The remote computing system 302 can be or include one or more server computing devices. For instance, the remote computing system 302 can be or include one or more datacenters, where a datacenter includes a plurality of server computing devices. Additionally or alternatively, the remote computing system 302 can be a distributed computing system.

The system 300 can also include one or more disparate computing systems 304. The disparate computing systems 304 can each be substantially similar to the computing system 106. Moreover, differing users can employ the disparate computing systems 304 (e.g., a user of at least one of the disparate computing systems 304 can differ from the user of the computing system 106). However, it is contemplated that the user of the computing system 106 can also employ one or more of the disparate computing systems 304.

The remote computing system 302 can collect and aggregate usage data (e.g., aggregated usage data 306) of a plurality of users for the functions of the computer-executable application 104 from the computing system 106 and the disparate computing systems 304. Again, it is contemplated that the remote computing system 302 can also collect and aggregate usage data for functions of differing computer-executable application(s) from the computing system 106 and the disparate computing systems 304. Further, the remote computing system 302 can transmit the aggregated usage data 306 (or a portion thereof) to the computing system 106 (e.g., the aggregated usage data 120). The remote computing system 302 can likewise transmit the aggregated usage data 306 to the disparate computing systems 304.

The computing system 106 can include the computer-executable application 104 and the interface customization system 112. The interface customization system 112 can further include a communication component 308 configured to receive, from the remote computing system 302, the aggregated usage data 306 of the plurality of the users for the functions of the computer-executable application 104. The aggregated usage data 306, for example, can specify a link between a first function of the computer-executable application 104 and a second function of the computer-executable application 104.

The interface customization system 112 can also include a tracking component 310 configured to collect individual usage data (e.g., the individual usage data 118) of the user for the functions of the computer-executable application 104 over time. The tracking component 310 can monitor usage of the functions of the computer-executable application 104 by the user. Moreover, the communication component 308 can be configured to transmit, to the remote computing system 302, the individual usage data of the user for the functions the computer-executable application 104 over time to the remote computing system 302 for inclusion as part of the aggregated usage data 306.

Following the example where the aggregated usage data 306 specifies the link between the first function and the second function of the computer-executable application 104, the personalization component 116 can be configured to identify a customization of a graphical control element for the first function of the computer-executable application 104 in the graphical user interface 102 for the user. The customization of the graphical control element for the first function can be identified by the personalization component 116 based on a frequency of use of the second function by the user indicated in the individual usage data of the user (e.g., as collected by the tracking component 310) and the link between the first function of the computer-executable application 104 and the second function of the computer-executable application 104. Moreover, the control component 124 can be configured to modify the graphical user interface 102 to incorporate the customization of the graphical control element for the first function of the computer-executable application 104.

Such customization of the graphical control element for the first function of the computer-executable application 104 in the graphical user interface 102 for the user can correspond to a first time. Moreover, the communication component 308 can be configured to receive updated aggregated usage data of the plurality of the users for the functions of the computer-executable application 104 corresponding to a second time. Additionally or alternatively, the tracking component 310 can be configured to collect updated individual usage data of the user for the functions of the computer-executable application 104 corresponding to the second time. Accordingly, the personalization component 116 can be configured to identify a customization of a differing graphical control element for a third function of the computer-executable application 104 in the graphical user interface 102 for the user. The differing graphical control element can be selectable to facilitate performance of the third function of the computer-executable application 104. The customization of the differing graphical control element for the third function of the computer-executable application 104 can be identified by the personalization component 116 based on the updated aggregated usage data of the plurality of the users for the functions of the computer-executable application 104 corresponding the second time and/or the updated individual usage data of the user for the functions of the computer-executable application 104 corresponding to the second time. For instance, the customization of the third function of the computer-executable application 104 can be determined by the personalization component 116 based on a change over time in the individual usage data and/or a change over time in the aggregated usage data. Further, the control component 124 can be configured to modify the graphical user interface 102 to incorporate the customization of the differing graphical control element for the third function of the computer-executable application 104.

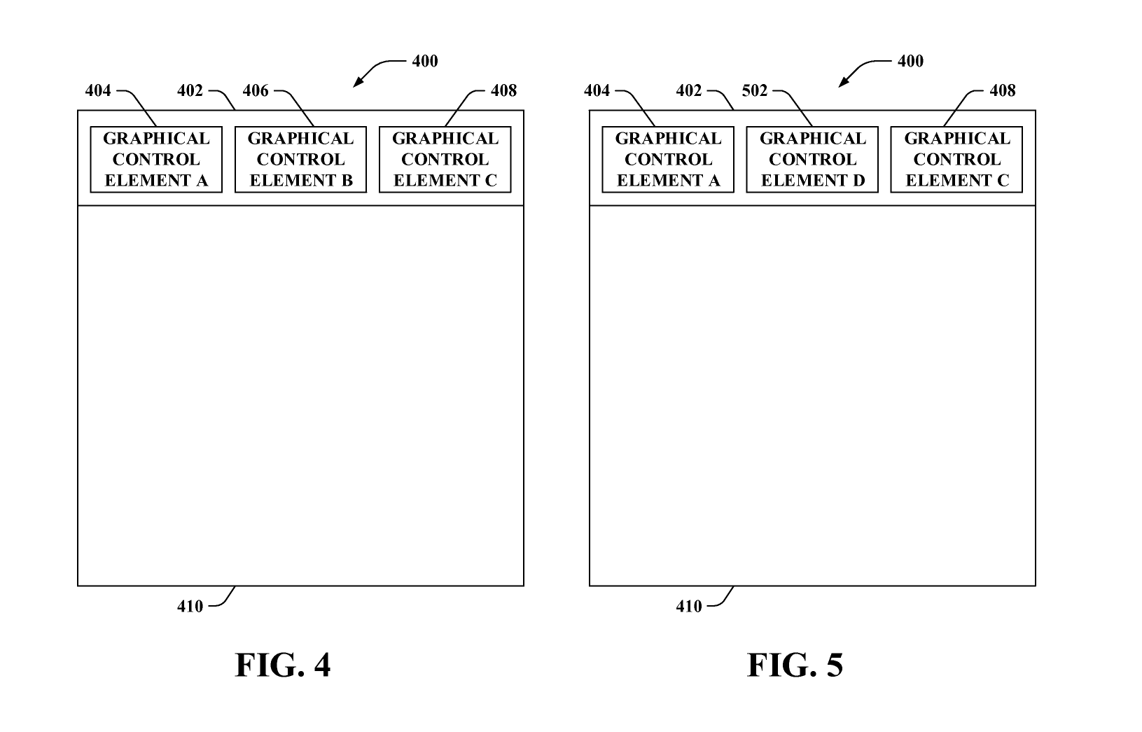

With reference to FIGS. 4-6, illustrated are various exemplary configurations of a graphical user interface 400 of a computer-executable application in accordance with various aspects. It is to be appreciated that the exemplary graphical user interface 400 is provided as an illustration, and the claimed subject matter is not limited to such illustration.

As depicted in FIG. 4, the exemplary graphical user interface 400 can include a toolbar 402. The toolbar 402 can include a number of graphical control elements, namely, a graphical control element A 404 (for a function A), a graphical control element B 406 (for a function B), and a graphical control element C 408 (for a function C). Moreover, the graphical user interface 400 can include a region 410, which can include content associated with the computer-executable application (e.g., a document edited using a word processing application, a website viewed using a web browser application, etc.).

According to an example, graphical control elements for functions of a computer-executable application that are used most frequently by the user (e.g., based on the individual usage data) can be surfaced in the toolbar 402. By way of illustration, the interface customization system 112 can recognize that function A, function D, and function C of the computer-executable application are most frequently used by the user. Accordingly, the interface customization system 112 can cause the graphical user interface 400 as depicted in FIG. 4 to be modified to include a graphical control element D (for the function D) and remove the graphical control element B 406 for the function B. Thus, as depicted in FIG. 5, a graphical control element D 502 can be included in the graphical user interface 400 (e.g., as part of the toolbar 402). By way of another example, it is contemplated that the graphical control element D 502 can be added to the toolbar 402 of the graphical user interface 400 without removal of the graphical control element B 406.

Moreover, graphical control elements for functions can be positioned within the graphical user interface 400 (e.g., within the toolbar 402) based on frequency of use by the user. Thus, graphical control elements of more frequently used functions can be positioned in more accessible locations as compared to graphical control elements of less frequently used functions. By way of illustration, assume that the graphical control element A 404, the graphical control element B 406, and the graphical control element C 408 are positioned relative to one another as shown in FIG. 4. If it is identified that function C is used more frequently than function A and function A is used more frequently than function B, then the graphical user interface 400 can be modified to reposition the graphical control element C 408, the graphical control element A 404, and the graphical control element B 406 as depicted in FIG. 6 (assuming that the position of the graphical control element C 408 is more accessible than the position of the graphical control element A 404, and the position of the graphical control element A 404 is more accessible than the position of the graphical control element B 406 in FIG. 6).

Moreover, it is to be appreciated that the foregoing examples can be extended to scenarios where graphical control elements for functions related to frequently used functions are added, removed, or repositioned within the graphical user interface 400.

Reference is again made to FIG. 4. Pursuant to an example, the toolbar 402 can be a sharing bar. Following this example, the graphical control element A 404 can cause content to be shared using a first sharing service, the graphical control element B 406 can cause content to be shared using a second sharing service, and the graphical control element C 408 can cause content to be shared using a third sharing service. The first, second, and third sharing services may be the sharing services used most frequently by a user, while less frequently used sharing services lack corresponding graphical control elements in the sharing bar. By way of illustration, if the frequency of use of the second sharing service decreases, then the graphical control element B 406 (corresponding to the second sharing service) can be minimized and/or deprecated.

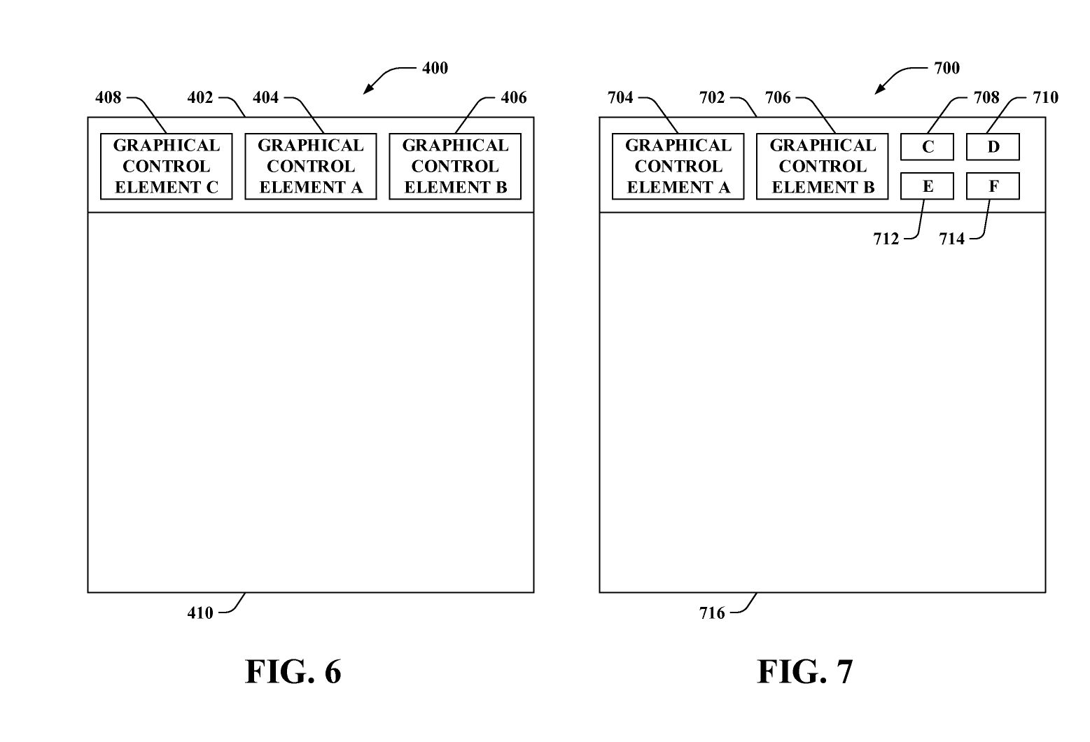

FIG. 7 illustrates another exemplary graphical user interface 700 of a computer-executable application. Again, the graphical user interface 700 is provided for illustration purposes, and the claimed subject matter is not so limited.

The graphical user interface 700 includes a toolbar 702, which includes a graphical control element A 704 (for a function A), a graphical control element B 706 (for a function B), a graphical control element C 708 (for a function C), a graphical control element D 710 (for a function D), a graphical control element E 712 (for a function E), and a graphical control element F 714 (for a function F). Further, the graphical user interface includes a region 716 that can include content associated with the computer-executable application.

As shown in FIG. 7, graphical control elements of differing sizes can be included in the graphical user interface 700. According to an example, the interface customization system 112 can control the sizes of the graphical control elements based on priority and/or frequency of use. For instance, a graphical control element can be resized in the graphical user interface 700.

According to another example, a basic and advanced options screen can have an area that places both most frequently accessed controls as well as controls that the interface customization system 112 identifies as being more likely to be needed by the user than others. According to another example, an application can be self-defining and self-creating, starting with simple functionality that enables best practices and then becomes more complicated and advanced as users interact with the computer-executable application over time.

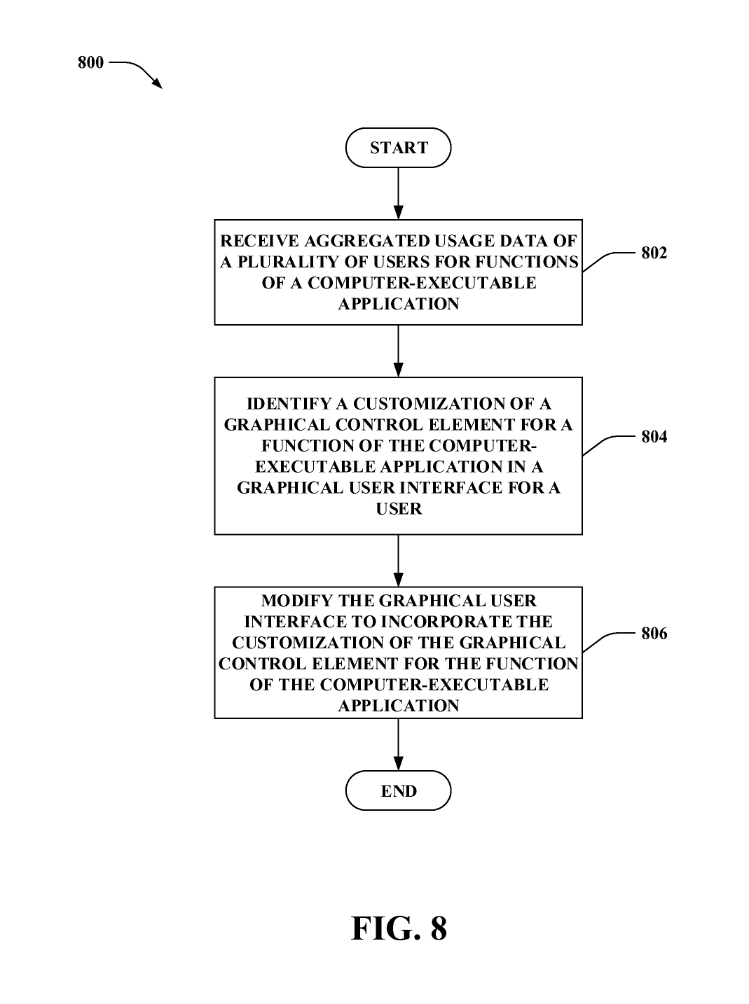

FIG. 8 illustrates an exemplary methodology relating to controlling customization of a graphical user interface. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium, displayed on a display device, and/or the like.

FIG. 8 illustrates a methodology 800 of managing a graphical user interface of a computer-executable application for a user. At 802, aggregated usage data of a plurality of users for functions of a computer-executable application can be received. The aggregated usage data can specify a link between a first function of the computer-executable application and a second function of the computer-executable. At 804, a customization of a graphical control element for the first function of the computer-executable application in a graphical user interface for the user can be identified. The graphical control element can be selectable to facilitate performance of the first function of the computer-executable application. The customization of the graphical control element for the first function of the computer-executable application can be identified based on individual usage data of the user for the functions of the computer-executable application and the aggregated usage data of the plurality of users for the functions of the computer-executable application. For example, the customization of the graphical control element for the first function of the computer-executable application can be identified based on a frequency of use of the second function by the user indicated in the individual usage data of the user and the link between the first function of the computer-executable application and the second function of the computer-executable application. At 806, the graphical user interface can be modified to incorporate the customization of the graphical control element for the first function of the computer-executable application.

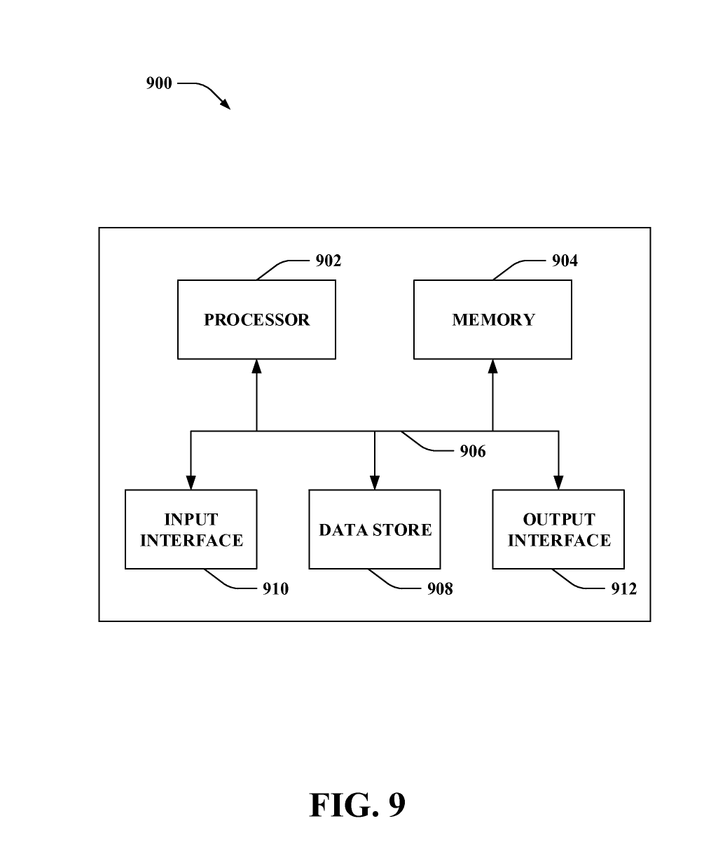

Referring now to FIG. 9, a high-level illustration of an exemplary computing device 900 that can be used in accordance with the systems and methodologies disclosed herein is illustrated. For instance, the computing device 900 may be used in a system that controls personalization of a graphical user interface of a computer-executable application for a user. By way of another example, the computing device 900 can be used in a system that collects and aggregates usage data of users for functions of a computer-executable application. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store individual usage data, aggregated usage data, and so forth.

The computing device 900 additionally includes a data store 908 that is accessible by the processor 902 by way of the system bus 906. The data store 908 may include executable instructions, individual usage data, aggregated usage data, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

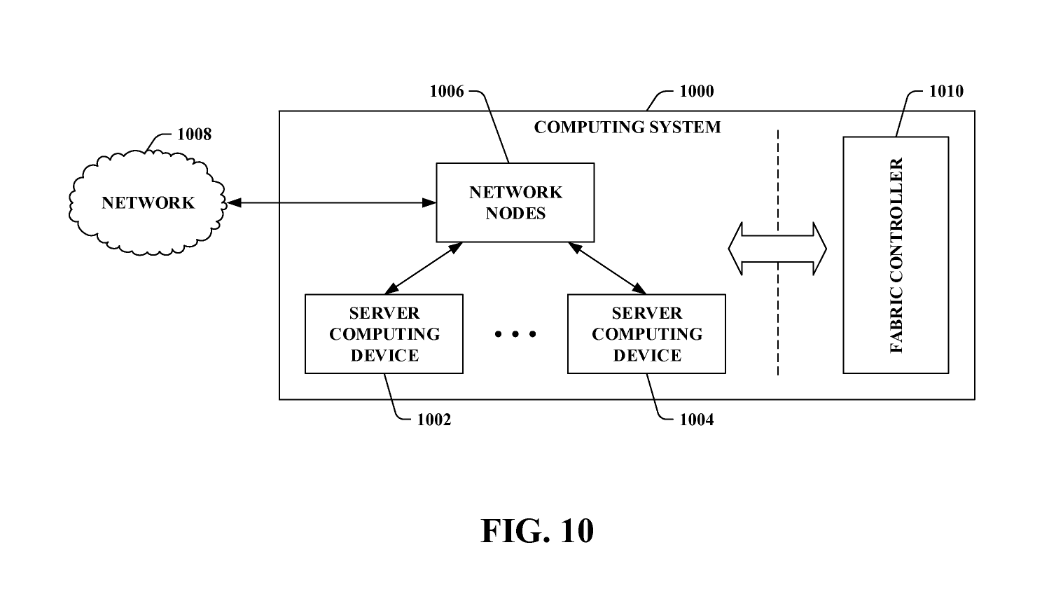

Turning to FIG. 10, a high-level illustration of an exemplary computing system 1000 that can be used in accordance with the systems and methodologies disclosed herein is illustrated. For instance, the computing system 1000 can be or include the computing system 106. Additionally or alternatively, the computing system 106 can be or include the computing system 1000. Moreover, the computing system 1000 can be or include the remote computing system 302, or the remote computing system 302 can be or include the computing system 1000.

The computing system 1000 includes a plurality of server computing devices, namely, a server computing device 1002, . . . , and a server computing device 1004 (collectively referred to as server computing devices 1002-1004). The server computing device 1002 includes at least one processor and a memory; the at least one processor executes instructions that are stored in the memory. The instructions may be, for instance, instructions for implementing functionality described as being carried out by one or more components discussed above or instructions for implementing one or more of the methods described above. Similar to the server computing device 1002, at least a subset of the server computing devices 1002-1004 other than the server computing device 1002 each respectively include at least one processor and a memory. Moreover, at least a subset of the server computing devices 1002-1004 include respective data stores.

Processor(s) of one or more of the server computing devices 1002-1004 can be or include the processor 108. Further, a memory (or memories) of one or more of the server computing devices 1002-1004 can be or include the memory 110. Moreover, a data store (or data stores) of one or more of the server computing devices 1002-1004 can be or include the data store 122.

The computing system 1000 further includes various network nodes 1006 that transport data between the server computing devices 1002-1004. Moreover, the network nodes 1002 transport data from the server computing devices 1002-1004 to external nodes (e.g., external to the computing system 1000) by way of a network 1008. The network nodes 1002 also transport data to the server computing devices 1002-1004 from the external nodes by way of the network 1008. The network 1008, for example, can be the Internet, a cellular network, or the like. The network nodes 1006 include switches, routers, load balancers, and so forth.

A fabric controller 1010 of the computing system 1000 manages hardware resources of the server computing devices 1002-1004 (e.g., processors, memories, data stores, etc. of the server computing devices 1002-1004). The fabric controller 1010 further manages the network nodes 1006. Moreover, the fabric controller 1010 manages creation, provisioning, de-provisioning, and supervising of virtual machines instantiated upon the server computing devices 1002-1004.

Various examples are now set forth.

### EXAMPLE 1

A computing system, comprising: at least one processor; and memory comprising an interface customization system configured to manage a graphical user interface of a computer-executable application for a user, the interface customization system being executable by the at least one processor, the interface customization system comprising: a personalization component configured to identify a customization of a graphical control element for a function of the computer-executable application in the graphical user interface for the user, the graphical control element being selectable to facilitate performance of the function of the computer-executable application, the customization of the graphical control element for the function of the computer-executable application being identified based on: individual usage data of the user for functions of the computer-executable application; and aggregated usage data of a plurality of users for the functions of the computer-executable application; and a control component configured to modify the graphical user interface to incorporate the customization of the graphical control element for the function of the computer-executable application.

### EXAMPLE 2

The computing system according to Example 1, the control component configured to automatically modify the graphical user interface to incorporate the customization of the graphical control element for the function of the computer-executable application without input from the user.

### EXAMPLE 3

The computing system according to any of Examples 1-2, the plurality of the users comprises users of the computer-executable application that share a characteristic with the user, and the plurality of the users excludes users of the computer-executable application that lack the characteristic.

### EXAMPLE 4

The computing system according to any of Examples 2-3, the interface customization system further comprising: a recommendation component configured to: generate a prompt that specifies the customization of the graphical control element for the function of the computer-executable application; and receive an input responsive to the prompt, the input indicative of one of acceptance or rejection of the customization of the graphical control element; and the control component further configured to: modify the graphical user interface to incorporate the customization of the graphical control element for the function of the computer-executable application responsive to receipt of the input indicative of acceptance of the customization of the graphical control element; and inhibit modification of the graphical user interface to incorporate the customization of the graphical control element for the function of the computer-executable application responsive to receipt of the input indicative of rejection of the customization of the graphical control element.

### EXAMPLE 5

The computing system according to any of Examples 1-4, the aggregated usage data of the plurality of the users for the functions of the computer-executable application specifies a link between the function of the computer-executable application and a differing function of the computer-executable application; and the personalization component further configured to identify the customization of the graphical control element for the function of the computer-executable application based on: a frequency of use of the differing function by the user indicated in the individual usage data of the user; and the link between the function of the computer-executable application and the differing function of the computer-executable application.

### EXAMPLE 6

The computing system according to any of Examples 1-5, the customization of the graphical control element comprises inclusion of the graphical control element for the function of the computer-executable application in the graphical user interface for the user.

### EXAMPLE 7

The computing system according to any of Examples 1-6, the customization of the graphical control element comprises repositioning the graphical control element for the function of the computer-executable application in the graphical user interface for the user.

### EXAMPLE 8

The computing system according to any of Examples 1-7, the customization of the graphical control element comprises removal of the graphical control element for the function of the computer-executable application from the graphical user interface for the user.

### EXAMPLE 9

The computing system according to any of Examples 1-8, the customization of the graphical control element comprises resizing of the graphical control element for the function of the computer-executable application in the graphical user interface for the user.

### EXAMPLE 10

The computing system according to any of Examples 1-9, the individual usage data of the user specifies respective frequencies of use of the functions of the computer-executable application by the user, and the aggregated usage data of the plurality of the users specifies respective frequencies of use of the functions of the computer-executable application by the plurality of the users.

### EXAMPLE 11

The computing system according to any of Examples 1-10, the interface customization system further comprising a communication component configured to receive, from a remote computing system, the aggregated usage data of the plurality of the users for the functions of the computer-executable application.

### EXAMPLE 12

The computing system according to any of Examples 1-11, the interface customization system further comprising a tracking component configured to collect the individual usage data of the user for the functions of the computer-executable application over time.

### EXAMPLE 13

The computing system according to any of Examples 1-12, wherein: at least one of the individual usage data of the user for the functions of the computer-executable application is updated over time or the aggregated usage data of the plurality of the users for the functions of the computer-executable application is updated over time; and the personalization component is further configured to identify the customization of the graphical control element for the function of the computer-executable application in the graphical user interface for the user at a given time based on at least one of: updated individual usage data of the user for the functions of the computer-executable application corresponding to the given time; or updated aggregated usage data of the plurality of the users for the functions of the computer-executable application corresponding to the given time.

### EXAMPLE 14

The computing system according to any of Examples 1-13, the aggregated usage data for the plurality of the users for the functions of the computer-executable application being for a version of the computer-executable application executed by the computing system, and the aggregated usage data for the plurality of the users for the functions of the computer-executable application excludes usage data for one or more differing versions of the computer-executable application.

### EXAMPLE 15

A method of managing a graphical user interface of a computer-executable application for a user, comprising: receiving aggregated usage data of a plurality of users for functions of the computer-executable application, the aggregated usage data specifies a link between a first function of the computer-executable application and a second function of the computer-executable application; identifying a customization of a graphical control element for the first function of the computer-executable application in the graphical user interface for the user, the graphical control element being selectable to facilitate performance of the first function of the computer-executable application, the customization of the graphical control element for the first function of the computer-executable application being identified based on: a frequency of use of the second function by the user indicated in individual usage data of the user; and the link between the first function of the computer-executable application and the second function of the computer-executable application; and modifying the graphical user interface to incorporate the customization of the graphical control element for the first function of the computer-executable application.

### EXAMPLE 16

The method according to Example 15, the link between the first function of the computer-executable application and the second function of the computer-executable application being indicative of a predefined relation between the first function and the second function.

### EXAMPLE 17

The method according to Example 15, the link between the first function of the computer-executable application and the second function of the computer-executable application being indicative of a correlation between respective frequencies of use of the first function and the second function in the aggregated usage data.

### EXAMPLE 18

The method according to any of Examples 15-17, the customization of the graphical control element for the first function of the computer-executable application in the graphical user interface for the user corresponding to a first time, the method further comprising: at least one of: receiving updated aggregated usage data of the plurality of the users for the functions of the computer-executable application corresponding to a second time; or collecting updated individual usage data of the user for the functions of the computer-executable application corresponding to the second time; identifying a customization of a differing graphical control element for a third function of the computer-executable application in the graphical user interface for the user, the differing graphical control element being selectable to facilitate performance of the third function of the computer-executable application, the customization of the differing graphical control element for the third function of the computer-executable application being identified based on at least one of: the updated aggregated usage data of the plurality of the users for the functions of the computer-executable application corresponding to the second time; or the updated individual usage data of the user for the functions of the computer-executable application corresponding to the second time; and modifying the graphical user interface to incorporate the customization of the differing graphical control element for the third function of the computer-executable application.

### EXAMPLE 19

The method according to any of Examples 15-18, further comprising: generating a prompt that specifies the customization of the graphical control element for the first function of the computer-executable application; receiving an input responsive to the prompt indicative of acceptance of the customization of the graphical control element; and modifying the graphical user interface to incorporate the customization of the graphical control element for the first function of the computer-executable application responsive to receipt of the input indicative of acceptance of the customization of the graphical control element.

### EXAMPLE 20

A computing system, comprising: at least one processor; and memory comprising an interface customization system configured to manage a graphical user interface of a computer-executable application for a user, the interface customization system being executable by the at least one processor, the interface customization system comprising: a personalization component configured to identify a customization of a graphical control element for a first function of the computer-executable application in the graphical user interface for the user, the graphical control element being selectable to facilitate performance of the first function of the computer-executable application, the customization of the graphical control element for the first function of the computer-executable application being identified based on: a frequency of use of a second function of the computer-executable application by the user indicated in individual usage data of the user for functions of the computer-executable application; and a link between the first function of the computer-executable application and the second function of the computer-executable application indicated in aggregated usage data of a plurality of users for the functions of the computer-executable application; and a control component configured to modify the graphical user interface to incorporate the customization of the graphical control element for the first function of the computer-executable application.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A computing system, comprising:
at least one processor; and
memory comprising an interface customization system configured to manage a graphical user interface of a computer-executable application for a user, the interface customization system being executable by the at least one processor, the interface customization system comprising:
a personalization component configured to identify a customization of a graphical control element for a function of the computer-executable application in the graphical user interface for the user, the graphical control element being selectable to facilitate performance of the function of the computer-executable application, the customization of the graphical control element for the function of the computer-executable application being identified based on:
individual usage data of the user for functions of the computer-executable application; and
aggregated usage data of a plurality of users for the functions of the computer-executable application; and
a control component configured to modify the graphical user interface to incorporate the customization of the graphical control element for the function of the computer-executable application.

2. The computing system of claim 1, the control component configured to automatically modify the graphical user interface to incorporate the customization of the graphical control element for the function of the computer-executable application without input from the user.

3. The computing system of claim 1, the plurality of the users comprises users of the computer-executable application that share a characteristic with the user, and the plurality of the users excludes users of the computer-executable application that lack the characteristic.

4. The computing system of claim 1, the interface customization system further comprising:
a recommendation component configured to:
generate a prompt that specifies the customization of the graphical control element for the function of the computer-executable application; and
receive an input responsive to the prompt, the input indicative of one of acceptance or rejection of the customization of the graphical control element; and
the control component further configured to:
modify the graphical user interface to incorporate the customization of the graphical control element for the function of the computer-executable application responsive to receipt of the input indicative of acceptance of the customization of the graphical control element; and
inhibit modification of the graphical user interface to incorporate the customization of the graphical control element for the function of the computer-executable application responsive to receipt of the input indicative of rejection of the customization of the graphical control element.

5. The computing system of claim 1, the aggregated usage data of the plurality of the users for the functions of the computer-executable application specifies a link between the function of the computer-executable application and a differing function of the computer-executable application; and
the personalization component further configured to identify the customization of the graphical control element for the function of the computer-executable application based on:
a frequency of use of the differing function by the user indicated in the individual usage data of the user; and
the link between the function of the computer-executable application and the differing function of the computer-executable application.

6. The computing system of claim 1, the customization of the graphical control element comprises inclusion of the graphical control element for the function of the computer-executable application in the graphical user interface for the user.

7. The computing system of claim 1, the customization of the graphical control element comprises repositioning the graphical control element for the function of the computer-executable application in the graphical user interface for the user.

8. The computing system of claim 1, the customization of the graphical control element comprises removal of the graphical control element for the function of the computer-executable application from the graphical user interface for the user.

9. The computing system of claim 1, the customization of the graphical control element comprises resizing of the graphical control element for the function of the computer-executable application in the graphical user interface for the user.

10. The computing system of claim 1, the individual usage data of the user specifies respective frequencies of use of the functions of the computer-executable application by the user, and the aggregated usage data of the plurality of the users specifies respective frequencies of use of the functions of the computer-executable application by the plurality of the users.

11. The computing system of claim 1, the interface customization system further comprising a communication component configured to receive, from a remote computing system, the aggregated usage data of the plurality of the users for the functions of the computer-executable application.

12. The computing system of claim 1, the interface customization system further comprising a tracking component configured to collect the individual usage data of the user for the functions of the computer-executable application over time.

13. The computing system of claim 1, wherein:
at least one of the individual usage data of the user for the functions of the computer-executable application is updated over time or the aggregated usage data of the plurality of the users for the functions of the computer-executable application is updated over time; and
the personalization component is further configured to identify the customization of the graphical control element for the function of the computer-executable application in the graphical user interface for the user at a given time based on at least one of:
updated individual usage data of the user for the functions of the computer-executable application corresponding to the given time; or
updated aggregated usage data of the plurality of the users for the functions of the computer-executable application corresponding to the given time.

14. The computing system of claim 1, the aggregated usage data for the plurality of the users for the functions of the computer-executable application being for a version of the computer-executable application executed by the computing system, and the aggregated usage data for the plurality of the users for the functions of the computer-executable application excludes usage data for one or more differing versions of the computer-executable application.

15. A method of managing a graphical user interface of a computer-executable application for a user, comprising:
receiving aggregated usage data of a plurality of users for functions of the computer-executable application, the aggregated usage data specifies a link between a first function of the computer-executable application and a second function of the computer-executable application;
identifying a customization of a graphical control element for the first function of the computer-executable application in the graphical user interface for the user, the graphical control element being selectable to facilitate performance of the first function of the computer-executable application, the customization of the graphical control element for the first function of the computer-executable application being identified based on:
a frequency of use of the second function by the user indicated in individual usage data of the user; and
the link between the first function of the computer-executable application and the second function of the computer-executable application; and
modifying the graphical user interface to incorporate the customization of the graphical control element for the first function of the computer-executable application.

16. The method of claim 15, the link between the first function of the computer-executable application and the second function of the computer-executable application being indicative of a predefined relation between the first function and the second function.

17. The method of claim 15, the link between the first function of the computer-executable application and the second function of the computer-executable application being indicative of a correlation between respective frequencies of use of the first function and the second function in the aggregated usage data.

18. The method of claim 15, the customization of the graphical control element for the first function of the computer-executable application in the graphical user interface for the user corresponding to a first time, the method further comprising:
at least one of:
receiving updated aggregated usage data of the plurality of the users for the functions of the computer-executable application corresponding to a second time; or
collecting updated individual usage data of the user for the functions of the computer-executable application corresponding to the second time;
identifying a customization of a differing graphical control element for a third function of the computer-executable application in the graphical user interface for the user, the differing graphical control element being selectable to facilitate performance of the third function of the computer-executable application, the customization of the differing graphical control element for the third function of the computer-executable application being identified based on at least one of:
the updated aggregated usage data of the plurality of the users for the functions of the computer-executable application corresponding to the second time; or
the updated individual usage data of the user for the functions of the computer-executable application corresponding to the second time; and
modifying the graphical user interface to incorporate the customization of the differing graphical control element for the third function of the computer-executable application.

19. The method of claim 15, further comprising:
generating a prompt that specifies the customization of the graphical control element for the first function of the computer-executable application;
receiving an input responsive to the prompt indicative of acceptance of the customization of the graphical control element; and
modifying the graphical user interface to incorporate the customization of the graphical control element for the first function of the computer-executable application responsive to receipt of the input indicative of acceptance of the customization of the graphical control element.

20. A computing system, comprising:
at least one processor; and
memory comprising an interface customization system configured to manage a graphical user interface of a computer-executable application for a user, the interface customization system being executable by the at least one processor, the interface customization system comprising:
a personalization component configured to identify a customization of a graphical control element for a first function of the computer-executable application in the graphical user interface for the user, the graphical control element being selectable to facilitate performance of the first function of the computer-executable application, the customization of the graphical control element for the first function of the computer-executable application being identified based on:
a frequency of use of a second function of the computer-executable application by the user indicated in individual usage data of the user for functions of the computer-executable application; and
a link between the first function of the computer-executable application and the second function of the computer-executable application indicated in aggregated usage data of a plurality of users for the functions of the computer-executable application; and
a control component configured to modify the graphical user interface to incorporate the customization of the graphical control element for the first function of the computer-executable application.
